(19) United States
(12) Patent Application Publication
(10) Pub. No.: US 2009/0084009 A1
(43) Pub. Date: Apr. 2, 2009

(54) Portable changeable illuminated display for vehicles and other miscellaneous purposes

(76) Inventors: Jon Vandergriff, Pasadena, CA (US); Harry L. Wainwright, Bethlehem, PA (US)

Correspondence Address: LAUSON & TARVER LLP, 880 APOLLO STREET, SUITE 301, EL SEGUNDO, CA, 90245, US

(21) Appl. No.: 12/070,969

(22) Filed: Feb. 22, 2008

Related U.S. Application Data
(60) Provisional application No. 60/995,842, filed on Oct. 1, 2007.

(51) Int. Cl. G09F 13/18; G09F 15/00

(52) U.S. Cl. 40/546; 40/606.01

(57) ABSTRACT

A mountable signage enclosure for encasing a graphic media comprising a frame being generally elliptic or having a substantially aerodynamic edge, an encasement for protectively displaying the graphic media through a clear covering through a front side of the mountable signage enclosure and allowing the exchange of the graphic media, a plurality of light emitting diodes perimetrically positioned to illuminate the encasement and the graphic media inserted therein, a power source for providing power to the light emitting diodes, a plurality of suction cups fixed to a back side of the mountable signage enclosure enabling the fixing of the mountable signage enclosure on a smooth surface; and optionally comprising a photovoltaic charging means providing an electric current for charging the power source. The mountable signage enclosure provides a stand-alone illuminated sign that can be easily installed in a variety of configurations, while allowing the quick exchange of the signage.

### RELATED APPLICATION DATA

This application claims the benefit of U.S. provisional application Ser. No. 60/995,842 filed Oct. 1, 2007.

### BACKGROUND OF THE INVENTION

1. Field of the Invention

The present invention relates to portable and attachable signage, and more particularly to illuminated signage with replaceable displays.

2. Description of the Related Art

There has risen a strong need to not only conserve energy in the growing world economies, but also to meet the demand for supplying more energy for the advertising and signage industries. It would then, seem as no surprise that a constant search for more energy efficient signage is ongoing. Hundreds of different configurations of illuminated signs exist in the market with as many uses, many requiring large amounts of current draw and significant maintenance. However, all seem to lack the portability enabling them to be removed and repositioned easily, allowing them to be applied or attached to various surfaces with ease and also have the ability to change alphanumeric characters and graphics with equal ease. Many also require wires to plug into power sources along with permanent structural supports for attaching them to surfaces. Others, being more limited in usage, are designed to be mounted on one particular product with a mounting configuration that prevents them from being mounted on any other product or object.

Many of the signs that allow for end user configuration are designed for changing house numbers and are intended to be mounted on porches or mailboxes. Looking at the art, U.S. Pat. No. 3,188,761 to Harrold and U.S. Pat. No. 3,404,474 to Johnson, both use mounting hardware that would prevent applications that require the removal and placement of a sign without the use of hardware brackets. Other existing technologies utilize electroluminescent (EL) back panel lighting to silhouette alphanumeric and graphic characters or to define the characters themselves. Adversely, these devices draw current levels requiring substantial power to keep them lighted for long periods of time, such as U.S. Pat. No. 3,680,237 to Finnerty, U.S. Pat. No. 3,680,238 to Arnold, U.S. Pat. No. 4,272,901 to Matthews, U.S. Pat. No. 4,327,511 to Rodriquez, U.S. Pat. No. 4,466,208 to Logan, and U.S. Pat. No. 5,709,045 to Thelen. Additionally, they require wires connected to external power sources. They are also designed to be used as permanent or semi-permanent fixtures as shown by U.S. Pat. No. 5,516,387 to Hoffman, wherein the sign is mounted on the inside of an automobile window using double sided adhesive tape and connected to wires leading to a power source remotely situated. These applications are intended for a single purpose and not designed to be removed and positioned elsewhere easily, due to the difficulty of removal and the marring and gumming of the window surface due to the removal of the adhesive tape.

Some illuminated signs use LED's to light up graphics. However, the enclosure designs prohibit these signs from being applied to the surface of vehicles due to their inherent problems with wind resistance. An example is shown in U.S. Pat. No. 4,903,172 to Schoniger, where the frame is built with a 90 degree bend and has no removable mounting means to secure it to the surface of a moving vehicle.

Other designs of prior art employ a method of pulsing the light source on and off to save energy or to energize phosphorescent sensitive chemicals such as ZnS in the print allowing the light to decay over a period of a few seconds during each flash impulse, such as seen in U.S. Pat. No. 4,016,450 to Balekjian. Flashing or blinking applications would not be applicable to vehicle signs due to safety concerns, such as the potentially dangerous distraction of neighboring drivers or laws prohibiting the flashing of particular colors.

Yet other signs offering energy saving options either rely on fluorescent tubes requiring power from outlets, such as U.S. Pat. No. 4,937,499 to Hunte and U.S. Pat. No. 4,989,956 to Wu, or are too bulky and use breakable materials such as glass tubes which offer too much wind resistance and potential breakage, qualities that are unsuitable for application to a vehicle.

Yet another method of illuminating a graphic, shown in U.S. Pat. No. 6,240,664 to Hjaltason, is to transmit light energy into polished edges of transparent acrylic plastic with an image printed on a substrate sandwiched between the two exterior sheets. This arrangement would add unnecessarily to the weight and bulkiness; and thick plastic elements that could shatter upon impact with other vehicles or the roadway if applied to a car sign. This is similar to the design offered by, U.S. Pat. No. 6,347,468 to Mohamed, disclosing a hand held portable sign for use with fluorescent markers, having no cavity to allow any type of inserts to be applied.

Prior art signage using incandescent, fluorescent signs, and signs using a multitude of LED's, such as shown in U.S. Pat. No. 7,217,012 to Southard where wires connect a series of LED's to form letters and graphics, all require excessive currents and voltages to attach to the sides of moving vehicles, are far too heavy and bulky offering tremendous wind resistance and potential danger of dislodging causing an accident, and are not conducive to easily changing the message once the wires, LED's and mounting hardware are in position.

Even signs that employ LED's to illuminate them are far too large and bulky, and present no easy way of mounting them to the side of a vehicle. Looking at U.S. Pat. No. 7,181,876 to Ahmadi, this device requires an enclosure and mounting bracket for the LED's. Some devices are designed to illuminate any signs using some type of LED enclosure as shown in U.S. Pat. No. 6,582,103 to Popovich. Popovich shows a cylindrical enclosure projecting light along a longitudinal axis to any sign; but offers no method of interchangeability or mounting methods to adhere the unit to a moving vehicle. Others use LED's to backlight or otherwise define graphics and letters, as shown in U.S. Pat. No. 7,162,821 to Venkataraman; which requires thick enclosures and current levels that would prohibit them from lighting signage for more than a few hours on a small battery, a battery being necessary to maintain a mounted frame on the side of a vehicle.

Existing art includes various patents disclosing electroluminescent panels for use in or on vehicles to provide a visual display of graphics and/or text. For example, U.S. Pat. No. 4,494,326 to Kanamori discloses a window mounted marker light for displaying a corporate logo or the type and model of the vehicle with wiring connecting to the vehicle's electrical system. U.S. Pat. No. 5,005,306 to Kinstler discloses a flexible electroluminescent sign arranged to be detachably attached to a vehicle, for example, on the vehicle's door, powered by the vehicles electrical system by wires placed through the door hinges. This arrangement would prove to be dangerous and unwieldy, due to the possibility of crimping the wiring and creating a short circuit.

U.S. Pat. No. 5,566,384 to Chien discloses an illuminated sign located in the window of a vehicle and on its bumper. The signs are made up of electroluminescent panels and associated power packs, where they can be attached to the vehicle by adhesion or other appropriate means. They do not have the ability to easily create, change, or modify the messages, nor can they apply photographic signs, nor can they illuminate fabric embroideries or support additional lighted inserts. U.S. Pat. No. 6,056,425 to Apelberg discloses an illuminated roof mounted sign assembly for a motor vehicle, such as a taxi. The assembly includes flexible electroluminescent panels over which a transparent panel bearing indicia, for example the word “TAXI”, is disposed for illuminating those indicia.

Some prior art illuminated signs also incorporate the use of Solar Cells to assist in powering signs as shown by U.S. Pat. No. 6,976,329 to Foster. However, the supporting structures are far too large to apply to a vehicle surface and are intended for applications outside of the use intended for vehicles.

While all of the foregoing devices may be suitable for their general purposes they still leave much to be desired from various standpoints, such as ease of use, ease of changing the display and/or its patterns, suitability for use with low current power supplies, ease of mounting on various types of support items, ease of changing displays, etc. Thus, a need exists for a device which addresses those issues.

Many existing signs are attached to the sides of vehicles using adhesives and do not offer the ability to change messages quickly. Many signs attachable to vehicles use magnets to attach them to the roofs of vehicles for advertising and identification such as custom made signs that require professional studios and graphic art printing houses to create, which take extended periods of time.

In addition, there is a need for businesses to be able to display pertinent information about their products and services in energy efficient, low-cost, dependable platform easily installed onto the surface of a vehicle without marring the surface luster and offer the ability to be removed easily without need of tools. There is also a need for a system that is able to address the needs of companies wishing to promote products in marketing campaigns and direct pertinent information through the use of displays attached to vehicles at selected times that can be changed quickly without discarding the entire sign structure.

Aside from businesses, there is a consumer need for the ability to add lighted decorations on personal vehicles that can be seen in the daylight and at night. Consumers will not pay graphic studios to design decorative prints to apply to their vehicles. Therefore, there is a need for a simple system to enable a consumer to design their own graphics to insert into a frame attachable to a vehicle for decorative or informative purposes. Additionally, since the advent of home computers has given consumers the ability to make their own signs, it has resulted in a need for a method in which a sign can not only be mounted on a vehicle for the purpose of displaying the aforementioned displays but also some method to temporarily display the sign mounted in a yard or on a horizontal surface such as a table, porch or rooftop, as well as having the sign fixable to other surfaces described herein.

### OBJECTS OF THE INVENTION

Accordingly, it is an object of the present invention to provide a signage enclosure that can be installed in a wide variety of applications, including car surfaces, on horizontal surfaces, staked into the ground, or hand held.

It is a further object of the present invention to provide a signage enclosure that can be illuminated for long periods without needing to be plugged in to an outlet.

It is a further object of the present invention to provide a signage enclosure that can be recharged by a photovoltaic panel.

It is a further object of the present invention to provide a signage enclosure that draws relatively low current so that the sign may be illuminated for long periods.

It is a further object of the present invention to provide a signage enclosure that allows for the easy exchange of signage.

It is a further object of the present invention to provide a signage enclosure that is compatible with a wide variety of signage.

It is a further object of the present invention to provide a signage enclosure that can provide power to a self illuminated sign.

These and other objects and advantages of the present invention will become apparent upon reading the following detailed description and upon reference to the accompanying drawings.

### SUMMARY OF THE INVENTION

A mountable signage enclosure for encasing a graphic media comprising in one or more embodiments a frame being generally elliptic and having a substantially aerodynamic edge, an encasement for protectively displaying the graphic media through a clear covering through a front side of the mountable signage enclosure and allowing the exchange of the graphic media, a plurality of light emitting diodes perimetrically positioned to illuminate the encasement and the graphic media inserted therein, a power source for providing power to the light emitting diodes, a plurality of suction cups fixed to a back side of the mountable signage enclosure enabling the fixing of the mountable signage enclosure on a smooth surface; and optionally comprising a photovoltaic charging means providing an electric current for charging the power source.

The photovoltaic charging means is preferably a commonly available photovoltaic cell. The cell providing a charge to the rechargeable battery during daylight hours, when the enclosure is likely in an off state, where the LED's are not illuminating the graphic media, the rechargeable batteries providing a power source during evening hours. The low power requirement of the LED's ensure that the power collected throughout the day is sufficient for lighting the enclosure through the evening. The graphic media itself may also be powered by the batteries to illuminate parts of the signage. So, the encasement can optionally have a contact for providing power to the graphic media inserted therein, at least a portion of the graphic media emitting light. The battery may be installed permanently within the enclosure being rechargeable or be replaceable as a non-rechargeable or rechargeable cell.

So that the mountable signage enclosure may be mounted, held, supported, or staked in a variety of situations in the displaying of the signage, a plurality of attachment points on the front side and the back side of the mountable signage enclosure for detachably retaining a support means in a socket-stud coupling may optionally be provided. The support means can be at least one detachable suction cup, when inserted on the front side the detachable suction cup providing support for the mountable signage enclosure directing the front side towards the smooth surface, when inserted on the back side the detachable suction cup providing support for the mountable signage enclosure directing the front side away the smooth surface and supplementing the suction cups permanently fixed. The support means can be an attachment base extending across the mountable signage enclosure and connecting to the attachment points on either side of the mountable enclosure; and the attachment base is configured to receive in attachment a handle for manually grasping the mountable signage enclosure as a hand-held display; and the handle is configured to receive in attachment a stake for insertion into the ground; and, additionally, the attachment base is configured to receive in attachment a stake for insertion into the ground.

The mountable signage enclosure may further comprise a support arm connected through a pivot to the back side, the pivot providing rotational resistance to maintain an angular position of the support arm, the support arm being selectively positioned to provide independent support on a surface.

The mountable signage enclosure encasement may also have a sensor for receiving external stimuli and affecting the state of the light emitting diodes based on the external stimuli, an electric circuit receiving a signal from the sensor and switching the light emitting diodes between an on state and an off state. The sensor can be a motion sensor, a light sensor, or a temperature sensor. To conserve power during operation, an electric circuit regulates power consumption utilizing a quiescent technology means.

The mountable signage enclosure may enclose a variety of graphic media, being made of materials such as paper, plastic fabric, composite, or rubber, wherein a graphic is printed thereon. For ease of use, the graphic media can be a standard sheet of paper being printed with a graphic by a home or an office printer having a width dimension of 8.5 inches and a length dimension of 11 inches. To create self illuminated signage, the graphic media can be comprised of a substrate, at least one onboard light emitting diode, and a plurality of plastic optical fibers axially receiving a light from the onboard light emitting diode each from a first end, the light propagating through the plastic optical fibers, the light being emitted from a second end attached to the substrate, an illumination pattern being determined by the position of the second end attached to the substrate, the contact providing power to the onboard light emitting diode.

To enable the easy and quick exchange of graphic media, the mountable signage enclosure may further comprise a flexible flap on the back side for providing access to the encasement through which the graphic media is inserted, the flap being biased in the closed position by an attachment means sealing the flap to the back side of the mountable signage enclosure.

This invention addresses all of the above concerns by offering a single molded frame with support mechanism attached to allow it to stand independent of any mounting hardware. The support mechanism allows the frame to mount on the inside or outside of an automobile window and accessories allow it to sit on a horizontal surface or stand independently supported on an extendable stake for yards. The frame is embedded with LED's contained within from the circumference lighting the inserted media within the shape of an aerodynamically efficient oval shape for directing air flow around the perimeter and over the surface. The oval frame is secured to the side of an automobile using strong suction cups that are easily removable and repositionable to alternative smooth surfaces such as glass windows, metal, Formica, plastic, etc. Two suction cups are able to be re-positioned in either direction to allow for internal and external mounting of the oval frame inside on car windows or on the sides of vehicle doors and frames.

In addition, the frame offers an opening in the center allowing smaller oval shaped plastic inserts containing messages, fiber optic or EL signs, and other accessory inserts that repel moisture and keep the internal paper, vinyl, or other printed material from becoming wet.

The cavity displaying alphanumeric characters and/or graphic sheets is large enough to insert a standard sheet of printed paper from a computer printer allowing consumers to design and print their own special graphics, messages, or company logos for display. The cavity is designed to also accommodate a thicker material insert such as fabric embroideries or even self-contained EL or fiber optic panels to display additional lighted messages with internal power supplies through the clear flexible vinyl window provided on the insert.

In addition, the frame contains a rechargeable battery pack that is continuously charged by a photovoltaic cell array protected by a clear coated epoxy-like substance to prevent damage from impact thus eliminating the necessity of changing batteries although a replaceable battery system falls under the intended embodiment of this invention as well.

One embodiment of this invention relates to using plastic optical fibers (POF) which are commonly referred to as light pipes able to channel light energy through flexible transparent strands to the opposite ends where the light escapes. The POF are meant to carry light energy to the surface from a series of LED's mounted on the opposing ends of the fibers attached to materials for the purpose of forming characters, phrases, and/or graphics designed for disseminating pertinent information on the surface in particular cases as will be described herein. Several strands of POF are connected to a single LED and the opposing ends are attached to a surface fabric, plastic, or other material in such a pattern as to define a portion of the sign display using the points that allow the light to escape thus eliminating the necessity of using a multitude of LED's to define each and every point themselves resulting in letters and graphic images. A single LED is able to light up multiple points used to define an entire letter or graphic image on the surface. Due to the ability of plastic optical fibers to attach to the surface of almost any surface through the use of various fixatives, the spacing of said fibers upon a sign's exterior surface portion allows for space left over in-between each point attachment which additional points of POF forming a different set of characters or graphics can be implanted into the same general area crossing the lines already implanted thus allowing for multiple messages to be implanted into the same surface area and lighted accordingly with different sets of diode attachments to the respective bundles making up each distinct set of characters. Lightweight and thin coin cell style batteries are able to power a display sign of this design for up to several nights with a photo-sensor installed designed to shut the power off during lighted hours. Prior art required heavy “security” style batteries meant to light up incandescent lights in signs which last for only a few hours during black out conditions.

Each LED is attached to a bundle containing a plurality of Plastic Optical Fibers (For example, Mitsubishi ESKA type high-grade plastic Optical Fibers), which can be implanted into the flexible material with their exterior ends permanently attached across the planar surface of the fabric. The optical fibers channel the light energy to the surface of the fabric transmitting it outward from the entire surface, not from a single fixed point as found in prior art using hard wired LED's. Any distinct pattern can be formed at the surface of the sign material using a plurality of optical fibers.

In another embodiment of the invention, the surface of each of the inserted fiber optic signs are designed to be physically unplugged from the frame power supply and replaced by surfaces containing other characters and/or graphics defined in fiber optics or EL which plug into the frame power supply replacing prior removable displays. This arrangement allows commercially available licensed characters and graphic products to be sold for use with this invention.

Another embodiment of this invention would be useful for temporary events that would require a different set of characters and messages during a specified time period or useful to advertise and market products in areas where electric power is not available such as in a market aisle or shelf space of retail stores containing products. In these applications, the displays would be able to blink on and off to attract attention while conserving energy.

Since this invention is designed to use a technique called, “Quiescent technology”, that is, lowering the current draw to conserve energy, a small battery pack could run a sign display for extended periods of time without need of replacing batteries. In this embodiment, advertisements running on the insert of the frame attached to a shelf display in a supermarket could run for months using four AA batteries to power such a unit. By turning off the unit by way of a motion sensor when no one was near the sign and using quiescent techniques in the software programming of the actual LED's when the sign was lighted, the average current draw would fall between 2-5 ma. for a typical lighted fiber optic lighted sign in this embodiment. Another embodiment of this invention allows the frame to surround and illuminate any object or printed message placed within the interior perimeter of the frame.

### BRIEF DESCRIPTION OF THE SEVERAL VIEWS OF THE DRAWINGS

FIGS. 1A-C are side views of the mountable signage enclosure, showing various mounting configurations.

FIGS. 2A-B are top and bottom views, respectively, of the mountable signage enclosure, the bottom view showing the internal arrangement of the circuitry.

FIGS. 3A-B show perspective exploded views of two possible configurations for self illuminated graphic media.

FIGS. 4A-B are side and bottom views of an alternate embodiment of the mountable signage enclosure.

FIGS. 5A-C show side views of three possible mounting attachments that are compatible with the mountable signage enclosure.

### LISTING OF REFERENCE NUMERALS FOR FIRST-PREFERRED EMBODIMENT

mountable signage enclosure 18
molded frame 20
suction cup 22, 24, 26, 28
LED 30, 32, 34, 36, 38, 40, 42, 44
hinge 46
support arm 48
pointed stake 50
surface 52
ground 54
aerodynamic beveling 56
photovoltaic cell 58, 60
switching circuit 62
wire 64
battery 66
plastic window 68
insert 70
attachment socket 72, 74
detachable suction cup 76
stud 78
contacts 80
encasement 82
lip 84
powered sign 85
fabric material 86
graphic 87
plastic optical fibers 88, 90, 92
bundle 94
LED 96
substrate 98
wire 100
jack 102
EL display 104
PCB 106
plastic surface 108
substrate 110
magnet 112, 114, 116
rail 118, 120
jack 122
flexible covering 124
metallic surface 126
stake 128
locking tab 130
extension arm 132
hole 134
mount 136
stud 138, 140
extension 142
rear 144

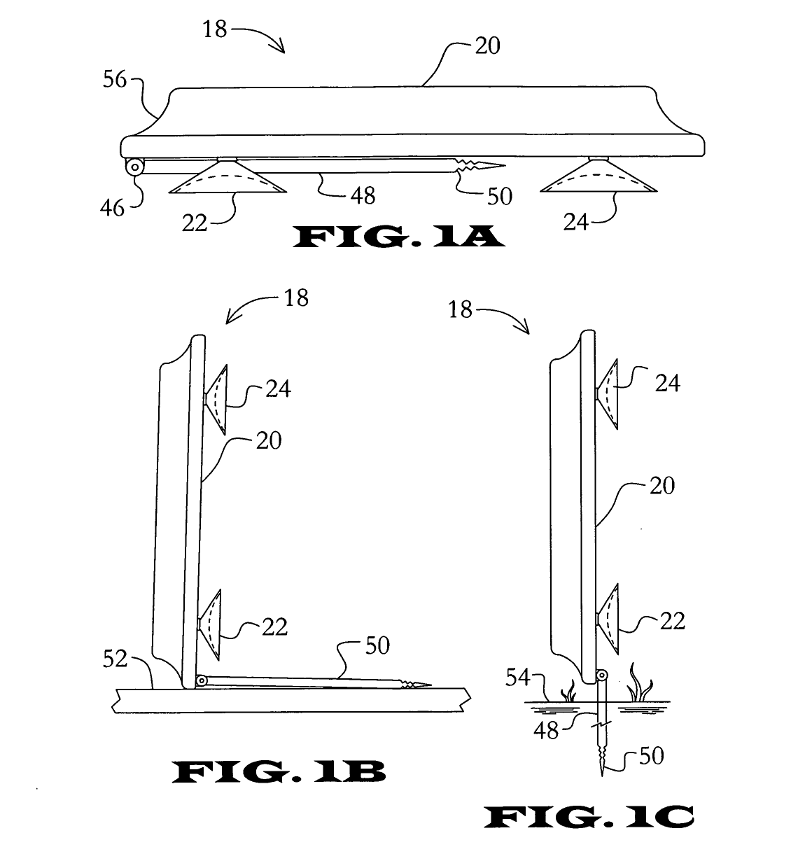

FIGS. 1A-C show side views of the mountable signage enclosure 18 with the plastic molded frame 20 with aerodynamic beveling 56. Located on the underside of the frame 20 are a series of flexible suction cups 22, 24, 26, 28 snapped into the underside of frame 20. Shown in the drawing is a snap-in support arm 48 containing a tight hinge 46 which has built-in resistance to movement allowing the support arm 48 to be pulled down to a ninety degree angle allowing the frame to sit on horizontal surface 52, as seen in FIG. 1B, but other support means are contemplated. When the support arm is extended to 180 degrees, the pointed stake 50 may be inserted into the ground 54 offering independent support. The support arm 48 can be removable for attachment to a vehicle thus lowering wind resistance and any potential scratching of painted surfaces.

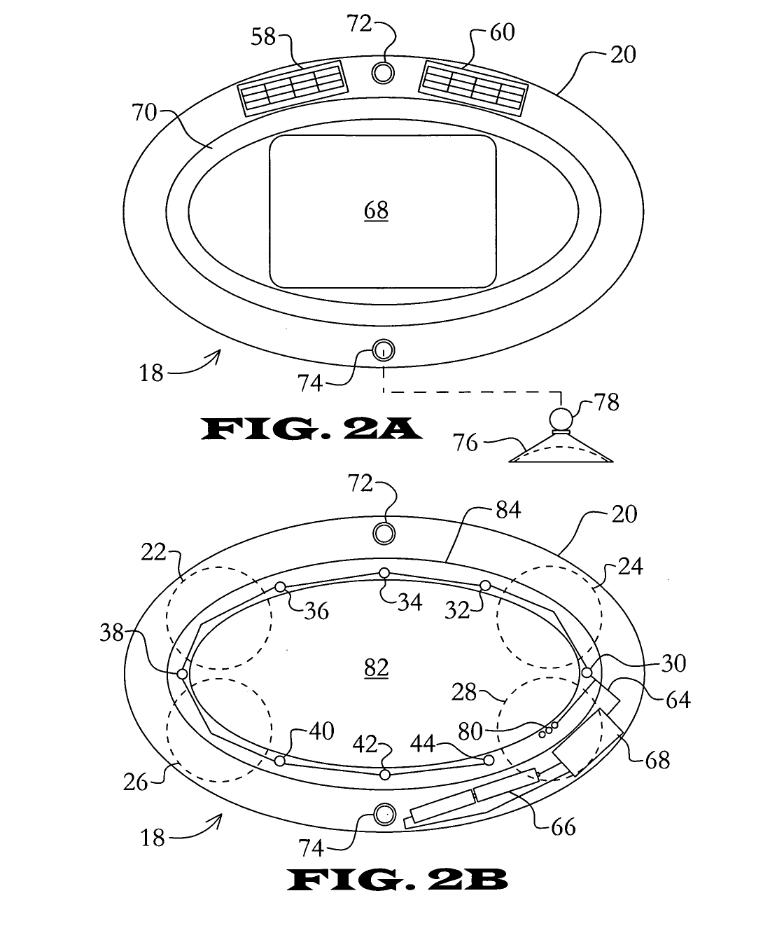

Referring now to FIGS. 2A-B, the mountable signage enclosure 18 has two photovoltaic cells 58, 60 for charging internal batteries 66. An additional insert 70 allows commercially printed oval graphics, photographs, signs, to fit perfectly within the frame 20 protected by a UV treated plastic window 68 that is designed to snap into the rear of the mountable signage enclosure 18. Consumers using standard printed paper measuring 8.5″ by 11″ will fit into the plastic window 68. Two attachment sockets 72, 74 are shown for the purpose of inserting additional detachable suction cups 76 with a stud 78 designed to snap through the sockets 72, 74 and mount the frame 20 facing outward against a window. Other accessory internal snap-in frames can contain other features such as fiber optic signs, EL, and commercially available inserts.

In FIG. 2B, show with the back cover removed and the suction cups 22, 24, 26, 28 in phantom, inside the molded frame 20 LED's 30, 32, 34, 36, 38, 40, 42, 44 are placed at even intervals along the perimeter just inside the exterior circumference of the frame pointed inward towards the center of the oval connected by a wire 64 to a battery 66 that is charged up during the day by photovoltaic cells 58, 60. The switching circuit 68 controls the switching from charge to discharge to and from respectively from batteries 66 to power the LED's 30, 32, 34, 36, 38, 40, 42, 44. Auxiliary contacts 80 are embedded into the interior side of the perimeter designed to make contact with electronic inserts (not shown) that require power. Two of the contacts provide power while the third contact or switch disconnects the LED's 30, 32, 34, 36, 38, 40, 42, 44 in the frame 20 from lighting shunting power to an internal insert when a matching contacts are positioned against the auxiliary contacts 80.

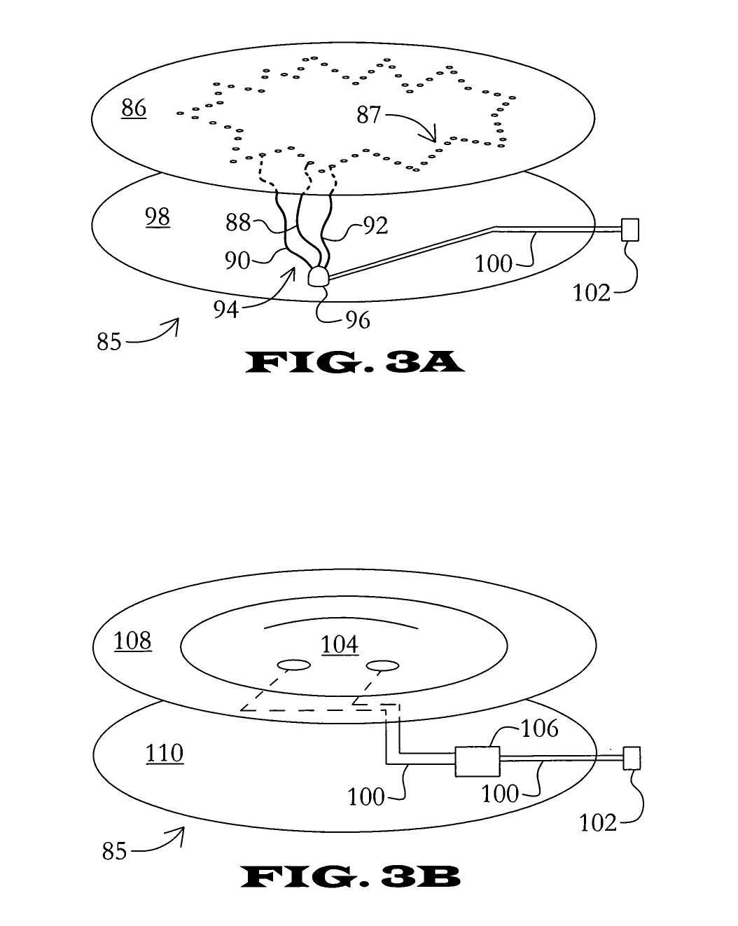

In FIG. 3A, a powered sign 85 is shown consisting of flexible fabric material 86 such as paper, vinyl, fabrics, etc. containing a plurality of plastic optical fibers (POF) 88, 90, 92 attached to the surface of the fabric material 86 using a clear fixative so that pluralities of points define a graphic 87, figure or letters, the total amount of individual fibers throughout the design make up the completed design on the fabric material 86 surface. The optical fibers 88, 90, 92 are channeled back into bundles 94 and connected to an LED 96 on their corresponding opposing ends so that the light energy fed into the optical fibers 88, 90, 92 is channeled through the fibers 88, 90, 92 to the surface of the fabric material 86 exiting from the points attached to the surface. The colors of the image seen are derived from the colors of the LED 88, 90, 92 outputs on the opposing ends of the fiber optic cables inside the insert. Wires 100 are connected to the LED 88, 90, 92 and lead out to a power jack 102 mounted inside the frame 20. In FIG. 3B, an EL display 104 on a thin plastic surface 108 may be inserted into the frame 20 cavity with wires 100 leading to the driver PCB 106 necessary to increase the voltage to activate the EL display 104 from power fed through the jack 102.

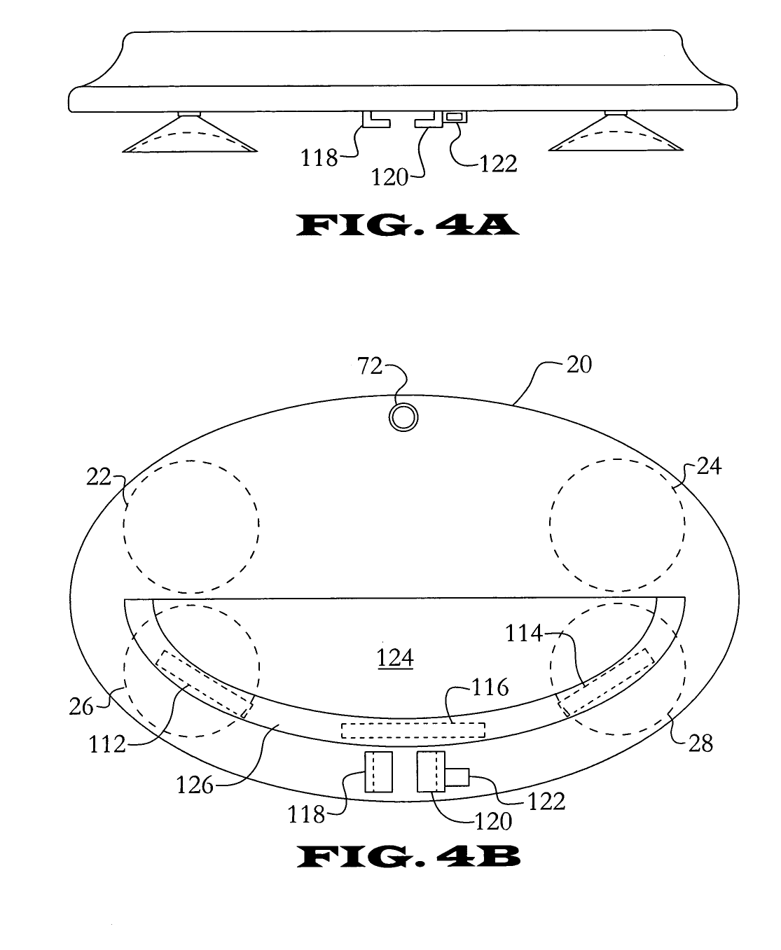

FIGS. 4A-B show another embodiment where the inserted portion is non-removable and the unit is one contiguous piece allowing no optional inserts to be applied to the rear side of the frame 20. Two opposing support rails 118, 120 are provided for mounting accessories in two positions, one for supporting the frame and the second for storing the support mechanism when using the suction cups for mounting the frame. A support arm 48 containing a hinge and stake component is shown in FIG. 1A, but other mechanisms are also obvious to the embodiment such as straight fixed position stakes to slide into the mounting slots.

A flexible vinyl covering 124 is opened and closed by way of small elongated magnets 112, 114, 116 as commonly found on items designed for refrigerator attachments which align with a metallic surface 126 directly underneath or by other means as may be used and is envisioned in this embodiment. Auxiliary jack 122 automatically shunts power to an internal insert (not shown) when a matching plug is inserted, if applicable.

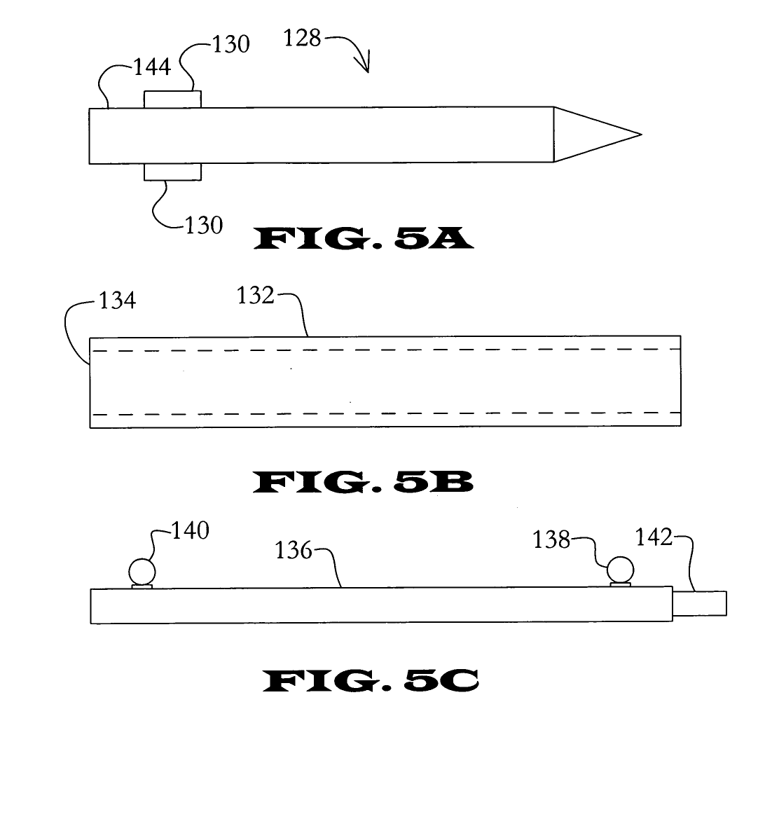

FIGS. 5A-C show one design concept for an accessory support stake 128 mechanism with locking tabs 130. The stake 128 is designed to insert the rear section 144 into the hole 134 of the extension arm 132, which, when used without the stake 128 becomes a handle for holding the oval frame in one's hand when inserted into the snap-on mount 136 supporting the frame 20. Two studs 140, 142 are inserted into sockets 72, 74 of FIG. 2A. The extension 132 is then inserted into the support arm 136 by way of extender portion 142 locking the two mechanisms together. Adding the additional stake 128 accessory is done by plugging the extension 132 into the rear 144 portion.

While particular forms of the invention have been illustrated and described, it will be also apparent to those skilled in the art that various modifications can be made without departing from the spirit and scope of the invention. Accordingly, it is not intended that the invention be limited except by the applied claims.

What is claimed is:

1. A mountable signage enclosure for encasing a graphic media comprising:
a frame having a substantially aerodynamic edge;
an encasement for protectively displaying the graphic media through a front side of the mountable signage enclosure and allowing the exchange of the graphic media;
a plurality of light emitting diodes perimetrically positioned to illuminate the encasement and the graphic media inserted therein;
a power source for providing power to the light emitting diodes;
a plurality of suction cups fixed to a back side of the mountable signage enclosure enabling the fixing of the mountable signage enclosure on a substantially smooth surface.

2. The mountable signage enclosure of claim 1 further comprising a photovoltaic charging means.

3. The mountable signage enclosure of claim 1 the encasement further comprising a contact for providing power to the graphic media inserted therein, at least a portion of the graphic media emitting light.

4. The mountable signage enclosure of claim 1 further comprising a plurality of attachment points on the front side and the back side of the mountable signage enclosure for detachably retaining a support means in a socket-stud coupling.

5. The mountable signage enclosure of claim 4 wherein the support means comprises at least one detachable suction cup so that when inserted on the front side, the detachable suction cup providing support for the mountable signage enclosure directing the front side towards the smooth surface and when inserted on the back side, the detachable suction cup providing support for the mountable signage enclosure directing the front side away from the smooth surface and supplementing the suction cups fixed to the back side.

6. The mountable signage enclosure of claim 4 wherein the support means is an attachment base extending across the mountable signage enclosure and connecting to the attachment points on either side of the mountable enclosure.

7. The mountable signage enclosure of claim 6 wherein the attachment base is configured to receive a handle for manually grasping the mountable signage enclosure as a hand-held display.

8. The mountable signage enclosure of claim 7 wherein the handle is configured to receive a stake for insertion into the ground.

9. The mountable signage enclosure of claim 6 wherein the attachment base is configured to receive a stake for insertion into the ground.

10. The mountable signage enclosure of claim 1 further comprising a support arm connected through a pivot to the back side, the pivot providing rotational resistance to maintain an angular position of the support arm, the support arm being selectively positioned to provide independent support on a surface.

11. The mountable signage enclosure of claim 1 the encasement further comprising a sensor for receiving external stimuli and affecting the state of the light emitting diodes based on the external stimuli, an electric circuit receiving a signal from the sensor and switching the light emitting diodes between an on state and an off state.

12. The mountable signage enclosure of claim 11 wherein the sensor is one of a motion sensor, a light sensor, or a temperature sensor.

13. The mountable signage enclosure of claim 1 wherein an electric circuit regulates power consumption utilizing a quiescent technology means.

14. The mountable signage enclosure of claim 1 wherein the power source is one of a rechargeable battery or a replaceable battery.

15. The mountable signage enclosure of claim 1 wherein a material comprising the graphic media is one of a paper, plastic fabric, composite, or rubber, wherein a graphic is printed thereon.

16. The mountable signage enclosure of claim 1 wherein the graphic media is a standard sheet of paper being printed with a graphic by a home or an office printer.

17. The mountable signage enclosure of claim 3 wherein the graphic media is comprised of a substrate, at least one onboard light emitting diode, and a plurality of plastic optical fibers axially receiving a light from the onboard light emitting diode each from a first end, the light propagating through the plastic optical fibers, the light being emitted from a second end attached to the substrate, an illumination pattern being determined by the position of the second end attached to the substrate, the contact providing power to the onboard light emitting diode.

18. The mountable signage enclosure of claim 1 further comprising a flexible flap on the back side for providing access to the encasement through which the graphic media is inserted, the flap being biased in the closed position by an attachment means sealing the flap to the back side of the mountable signage enclosure.

19. A mountable signage enclosure for encasing a graphic media comprising:
a frame being generally elliptic and having a substantially aerodynamic edge;
an encasement for protectively displaying the graphic media through a clear covering through a front side of the mountable signage enclosure and allowing the exchange of the graphic media;
a plurality of light emitting diodes perimetrically positioned to illuminate the encasement and the graphic media inserted therein;
a power source for providing power to the light emitting diodes;
a plurality of suction cups fixed to a back side of the mountable signage enclosure enabling the fixing of the mountable signage enclosure on a smooth surface;
a photovoltaic charging means providing an electric current for charging the power source;
a plurality of attachment points on the front side and the back side of the mountable signage enclosure for detachably retaining a support means in a socket-stud bond.

20. A method for the illuminated display of graphic media comprising the steps of:
a. inserting the graphic media into a mountable signage enclosure comprising a frame with a substantially aerodynamic edge, an encasement for protectively displaying the graphic media, a plurality of light emitting diodes perimetrically positioned, a power source, and a plurality of suction cups fixed to a back side;
b. attaching the signage enclosure to a substantially smooth surface by the suction cups;
c. illuminating the graphic media with the light emitting diodes positioned perimetrically.
